(19) United States
(12) Patent Application Publication
(10) Pub. No.: US 2002/0049725 A1
(43) Pub. Date: Apr. 25, 2002

(54) Item combination presenting apparatus, item combination presenting system, item combination presenting method and item information presenting method

(76) Inventor: Motoki Nakade, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 09/855,805

(22) Filed: May 16, 2001

(30) Foreign Application Priority Data
May 19, 2000 (JP) P2000-149099

(51) Int. Cl. G06F 7/00

(52) U.S. Cl. 707/1

(57) ABSTRACT

In item combination presenting apparatus, method and system and an item information presenting method, there are provided an accumulating portion for item information as user information, item attribute information as attribute information representing selecting standards of items, space information as information representing a space in which the items are arranged, and space attribute information as attribute information representing selecting standards of the space over plural pieces, a searching portion for searching space information having space attribute information specified and item information having the same item attribute information as the space attribute information in response to a request for specifying space attribute information from a terminal device, a calculating portion for calculating, on the basis of the item information and the space information, item combination arrangement information when the item information is arranged in the space information, and a transmitting portion for transmitting the item combination arrangement information to the terminal device.

### BACKGROUND OF THE INVENTION

1. Field of the Invention

The present invention relates to an item combination presenting apparatus, an item combination presenting system, an item combination presenting method and an item information presenting method in which plural users favorite articles are spatially arranged and presented through a network in accordance with users, demands.

2. Description of the Related art

There has been proposed a method in which a user is made to select his/her favorite goods (articles) relating to his/her life from life-relating goods accumulated in a data base by using a user's terminal connected to the Internet and then arrange these favorite goods in a structural space, whereby the user can create a user's more favorite design even when the user has no special knowledge on the design.

The life-relating goods arranged in the design thus created contain information on dealers which present these goods, and thus the user can purchase his/her favorite goods in the on-line style by accessing the goods from the user's terminal device.

According to this method, goods accumulated in a data base are transmitted to and displayed in advance on a user's terminal device in the form of image information every individual article, and a user selects his/her desired goods (some pieces of goods) from an image information group on the goods thus transmitted by using a mouse or the like to arrange the desired goods in a virtual space of the terminal device, for example, a space imitating a desired room in which the user wants to arrange the articles.

Accordingly, the user must select his/her desired goods from the image information group of many pieces of goods displayed on a terminal device and arrange these goods piece by piece by manipulating a mouse or the like, and this operation is very cumbersome and needs much labor.

Further, for goods-presenting dealers who present goods to users, the goods are presented to users while they are the same in value to the users, and thus no consideration is paid to the business strategies on buying and selling at the dealer's side. Therefore, the dealers cannot hope increasing business developments.

### SUMMARY OF THE INVENTION

Therefore, the present invention has been implemented to solve the above problem, and has an object to provide an item combination presenting apparatus, an item combination presenting system, an item combination presenting method and an item information presenting method with which a combination of goods coincident with user's fancy is presented by a simpler operation and also dealers can supply goods in conformity with their business developments.

In order to attain the above object, according to the present invention, an item combination presenting apparatus for presenting an item combination proposal to a terminal device connected to a network, is characterized by comprising: accumulating means for accumulating plural pieces of item information corresponding to information on items, plural pieces of item attribute information corresponding to attribute information representing selection standards of the item information, plural pieces of space information corresponding to information representing a space in which items are arranged, and plural pieces of space attribute information corresponding to attribute information representing selection standards of the space information; searching means for searching, in response to a request for specifying space attribute information input from a terminal device, space information having space attribute information thus specified and item information having the same item attribute information as the space attribute information from the space information and the item information accumulated in the accumulating means; calculating means for calculating, on the basis of the item information and the space information searched by the searching means, item combination arrangement information representing the arrangement of the item information in the space information; and transmitting means for transmitting the item combination arrangement information thus calculated by the calculating means to the terminal device.

In order to attain the above object, according to the present invention, an item combination presenting method for presenting an item combination proposal to a terminal device connected to a network, is characterized in that plural pieces of item information corresponding to information on items, plural pieces of item attribute information corresponding to attribute information representing selection standards of the item information, plural pieces of space information corresponding to information representing a space in which items are arranged, and plural pieces of space attribute information corresponding to attribute information representing selection standards of the space information are accumulated, in response to a request for specifying space attribute information input from a terminal device, space information having space attribute information thus specified and item information having the same item attribute information as the space attribute information are searched from the space information and the item information thus accumulated, on the basis of the item information and the space information thus searched, item combination arrangement information representing the arrangement of the item information in the space information is calculated, and the item combination arrangement information thus calculated is transmitted to the terminal device.

In order to attain the above object, according to the present invention, an item combination presenting system in which an item presenting terminal device for presenting items, an item combination presenting device for presenting to a terminal device an item combination proposal of the items presented from the item presenting terminal device, and a terminal device for presenting the item combination proposal presented from the item combination presenting device to a user are connected to one another through a network, is characterized in that: the item presenting terminal device includes first transmitting means for transmitting item information corresponding to information on items the combination of which the item combination presenting device presents, and item attribute information corresponding to attribute information representing selection standards of the item information; the item combination presenting device includes first reception means for receiving the item information and the item attribute information transmitted by the first transmitting means of the item presenting terminal device, accumulating means for accumulating plural pieces of item information and item attribute information received by the first reception means, plural pieces of space information corresponding to information representing a space in which items are arranged, and plural pieces of space attribute information corresponding to attribute information representing selection standards of the space information, searching means for searching, in response to a request for specifying space attribute information input from a terminal device, space information having space attribute information thus specified and item information having the same item attribute information as the space attribute information from the space information and the item information accumulated in the accumulating means, calculating means for calculating, on the basis of the item information and the space information searched by the searching means, item combination arrangement information representing the arrangement of the item information in the space information, and second transmitting means for transmitting the item combination arrangement information thus calculated by the calculating means to the terminal device; and the terminal device includes input means for receiving the request for specifying the space attribute information, second reception means for receiving item combination information transmitted from the second transmitting means of the item combination presenting device, and display means for displaying the item combination information received by the second reception means.

In order to attain the above object, according to the present invention, an item combination presenting method in which an item presenting terminal device for presenting items, an item combination presenting device for presenting to a terminal device an item combination proposal of the items presented from the item presenting terminal device, and a terminal device for presenting the item combination proposal presented by the item combination presenting method to a user are connected to one another through a network, is characterized in that: the item presenting terminal device transmits item information corresponding to information on items the combination of which the item combination presenting device presents, and item attribute information corresponding to attribute information representing selection standards of the item information; the item combination presenting device receives the item information and the item attribute information transmitted by the item presenting terminal device, and accumulates plural pieces of item information and item attribute information received, plural pieces of space information corresponding to information representing a space in which items are arranged, and plural pieces of space attribute information corresponding to attribute information representing selection standards of the space information; and the terminal device receives a request for specifying the space attribute information, wherein the item combination presenting device searches, in response to a request for specifying space attribute information input from a terminal device, the space information having the space attribute information specified from the space information and the item information accumulated, and the item information having the same item attribute information as the space attribute information, calculates, on the basis of the item information and the space information searched, item combination arrangement information representing the arrangement of the item information in the space information, and transmits the item combination arrangement information thus calculated to the terminal device, and the terminal device receives the item combination information transmitted from the item combination presenting device and displays the item combination information thus received.

In order to attain the above object, according to the present invention, an item combination presenting system in which an item presenting terminal device for presenting items, an item combination presenting device for presenting an item combination proposal of items presented by the item presenting terminal device to a terminal device, and a terminal device for presenting the item combination proposal presented by the item combination method to a user are connected to one another through a network, is characterized in that: the item presenting terminal device includes registration application means for making a registration application of the items the combination of which the item combination presenting device presents, registration charge payment means for paying through the network the registration charge to be paid to the item combination presenting device when the registration application is made by the registration application means, and first transmitting means for transmitting item information corresponding to the information of items for which the registration application is made to the item combination device by the registration application means, and item attribute information corresponding to the attribute information representing the selection standards of the item information; the item combination presenting device includes registering means for registering as combination-presented items items the registration application of which is made by the registration application means of the item presenting terminal device, first receiving means for receiving the item information and the item attribute information transmitted by the first transmitting means of the item presenting terminal device, accumulating means for accumulating plural pieces of item information and item attribute information received by the first receiving means, plural pieces of space information corresponding to information representing a space in which items are arranged, and plural pieces of space attribute information corresponding to attribute information representing selection standards of the space information, searching means for searching, in response to a request for specifying space attribute information input from the terminal device, the space information having the space attribute information thus specified and the item information having the same item attribute information as the space attribute information from the space information and the item information accumulated in the accumulation means, priority order determining means for determining a priority order so that an item for which the highest registration charge is paid by the registration charge payment means of the item presenting device is preferentially selected for an item combination to be presented from the items having the item information searched by the searching means, calculation means for calculating item combination arrangement information representing the arrangement of the item information in the space information, on the basis of the item information and the space information searched by the searching means according to the priority order determined by the priority order determining means and second transmitting means for transmitting the item combination arrangement information calculated by the calculating means to a terminal device; and the terminal device includes input means for receiving a request for specifying space attribute information, second receiving means for receiving the item combination information transmitted from the second transmitting means of the item combination presenting device, and display means for displaying the item combination information received by the second receiving means.

In order to attain the above object, according to the present invention, an item combination presenting method in which an item presenting terminal device for presenting items, an item combination presenting device for presenting an item combination proposal of items presented by the item presenting terminal device to a terminal device, a terminal device for presenting the item combination proposal presented by the item combination presenting method to a user are connected to one another through a network, is characterized in that: the item presenting terminal device applies the registration of the items which the combination is presented by the item combination presenting device and pays the registration charge to the item combination presenting device through the network when the registration application is made; the item combination presenting device registers the registration-applied items as combination-presented items; the item presenting terminal device transmits the item information corresponding to the information on the items registration-applied to the item combination device and the item attribute information corresponding to the attribute information representing the selection standards of the item information; the item combination presenting device receives the item information and the item attribute information transmitted from the item presenting terminal device, and accumulates plural pieces of item information and plural pieces of item attribute information thus received, and plural pieces of space information corresponding to the information representing a space in which the items are arranged, and plural pieces of space attribute information corresponding to attribute information representing the selection standards of the space information; the terminal device receives a request for specifying the space attribute information; the item combination presenting device searches, in response to the request for specifying the space attribution information input from the terminal device, the space information having the specified space attribute information and the item information having the same item attribute information as the space attribute information from the space information and the item information accumulated, determines a priority order so that an item in the items having the searched item information for which the highest registration charge is paid by the item presenting device is preferentially adopted for an item combination to be presented, calculates item combination arrangement information representing the arrangement of the item information in the space information according to the determined priority order on the basis of the item information and the space information thus searched, and transmits the item combination arrangement information thus calculated to the terminal device; and the terminal device receives the item combination information transmitted from the item combination presenting device, and displays the item combination information thus received.

In order to attain the above object, according to the present invention, an item combination presenting apparatus for presenting an item combination proposal to a terminal connected thereto through a network, is characterized by including: accumulating means for accumulating plural pieces of item information corresponding to information on items, plural pieces of item attribute information corresponding to attribute information representing the selection standards of the item information, plural pieces of target item information corresponding to information representing target items arranged simultaneously with the items, and plural pieces of target item attribute information corresponding to attribute information representing the selection standards of the target items; searching means for searching, in response to a request for specifying target item attribute information input from the terminal device, the target item information having the specified target item attribute information and the item information having the same item attribute information as the target item attribute information from the target item information and the item information accumulated in the accumulating means; calculating means for calculating item combination arrangement information representing the simultaneous arrangement of the item information and the target item information on the basis of the item information searched by the searching means and the target item information searched by the searching means; and transmitting means for transmitting the item combination arrangement information calculated by the calculating means to the terminal device.

In order to attain the above object, according to the present invention, an item combination presenting method for presenting an item combination proposal to a terminal connected through a network, is characterized in that plural pieces of item information corresponding to information on items, plural pieces of item attribute information corresponding to attribute information representing the selection standards of the item information, plural pieces of target item information corresponding to information representing target items arranged simultaneously with the items, and plural pieces of target item attribute information corresponding to attribute information representing the selection standards of the target items are accumulated; in response to a request for specifying target item attribute information input from the terminal device, the target item information having the specified target item attribute information and the item information having the same item attribute information as the target item attribute information are searched from the target item information and the item information accumulated; item combination arrangement information representing the simultaneous arrangement of the item information and the target item information is calculated on the basis of the item information and the target item information thus searched; and the item combination arrangement information thus calculated is transmitted to the terminal device.

In order to attain the above object, according to the present invention, an item combination presenting system in which an item presenting terminal device for presenting items, an item combination presenting device for presenting an item combination proposal of items presented by the item presenting terminal device to a terminal device, and a terminal device for presenting the item combination proposal presented by the item combination presenting method to a user are connected to one another through a network, is characterized in that: the item presenting terminal device includes first transmitting means for transmitting item information corresponding to information on items for which a combination is presented by the item combination presenting device, and item attribute information corresponding to attribute information representing selection standards of the item information; the item combination presenting device includes first receiving means for receiving the item information and the item attribute information transmitted by the transmitting means of the item presenting terminal device, accumulating means for accumulating plural pieces of item information and plural pieces of item attribute information received by the receiving means, plural pieces of target item information corresponding to information representing target items arranged simultaneously with the items, and plural pieces of target item attribute information corresponding to attribute information representing selection standards of the target item information, searching means for searching, in response to a request for specifying target item attribute information input from the terminal device, the target item information having the specified target item attribute information and the item information having the same item attribute information as the target item attribute information from the target item information and the item information accumulated in the accumulating means, calculating means for calculating item combination arrangement information representing the simultaneous arrangement of the item information and the target item information on the basis of the item information searched by the searching means and the target item information searched by the searching means, and second transmitting means for transmitting the item combination arrangement information calculated by the calculating means to the terminal device; and the terminal device includes input means for receiving the request for specifying the target item attribute information, second receiving means for receiving the item combination information transmitted from the second transmitting means of the item combination presenting device, and display means for displaying the item combination information received by the second receiving means.

In order to attain the above object, according to the present invention, an item combination presenting method in which an item presenting terminal device for presenting items, an item combination presenting device for presenting an item combination proposal of items presented by the item presenting terminal device to a terminal device, and a terminal device for presenting the item combination proposal presented by the item combination presenting device to a user are connected to one another through a network, is characterized in that: the item presenting terminal device transmits item information corresponding to information on items for which a combination is presented by the item combination presenting device, and item attribute information corresponding to attribute information representing selection standards of the item information; the item combination presenting device receives the item information and the item attribute information transmitted from the item presenting terminal device, accumulates plural pieces of item information and plural pieces of item attribute information thus received, plural pieces of target item information corresponding to information representing target items arranged simultaneously with the items, and plural pieces of target item attribute information corresponding to attribute information representing selection standards of the target item information, searches, in response to a request for specifying target item attribute information input from the terminal device, the target item information having the specified target item attribute information and the item information having the same item attribute information as the target item attribute information from the target item information and the item information accumulated, calculates item combination arrangement information representing the simultaneous arrangement of the item information and the target item information on the basis of the item information and the target item information searched, and transmits the item combination arrangement information thus calculated to the terminal device; and the terminal device receives the item combination information transmitted from the item combination presenting device, and displays the item combination information received.

In order to attain the above object, according to the present invention, an item combination presenting system in which an item presenting terminal device for presenting items, an item combination presenting device for presenting an item combination proposal of items presented by the item presenting terminal device to a terminal device, and a terminal device for presenting the item combination proposal presented by the item combination presenting method to a user are connected to one another through a network, is characterized in that: the item presenting terminal device includes registration application means for applying the registration of items the combination of which the item combination presenting device presents, registration charge payment means for paying the registration charge to the item combination presenting device through the network when the registration application is made by the registration applying means, and first transmitting means for transmitting item information corresponding to information of items for which the registration application is made to the item combination device by the registration application means, and item attribute information corresponding to attribute information representing selection standards of the item information; the item combination presenting device includes registering means for registering as combination-presented items the items registration-applied by the registration application means of the item presenting terminal device, first receiving means for receiving the item information and the item attribute information transmitted from the first transmitting means of the item presenting terminal device, accumulating means for accumulating plural pieces of item information and item attribute information received by the first receiving means, plural pieces of target item information corresponding to information representing target items to be arranged simultaneously with the items, and plural pieces of target item attribute information corresponding to attribute information representing selection standards of the target item information, searching means for searching, in response to a request for specifying the target item attribute information input from the terminal device, the target item information having the specified target item attribute information and the item information having the same item attribute information as the target item attribute information from the target item information and the item information accumulated in the accumulating means, priority order determining means for determining a priority order so that an item for which the highest registration charge is paid by the registration charge payment means of the item presenting device in the items having the item information searched by the searching means is preferentially adopted for the item combination to be presented, calculating means for calculating item combination arrangement information representing the simultaneous arrangement of the item information and the target item information according to the priority order determined by the priority order determining means on the basis of the item information and the target item information searched by the searching means, and second transmitting means for transmitting the item combination arrangement information calculated by the calculating means to the terminal device; and the terminal device includes input means for receiving the request for specifying the target item attribute information, second receiving means for receiving the item combination information transmitted from the second transmitting means of the item combination presenting device, and display means for displaying the item combination information received by the second receiving means.

In order to attain the above object, according to the present invention, an item combination presenting method in which an item presenting terminal device for presenting items, an item combination presenting device for presenting an item combination proposal of items presented by the item presenting terminal device to a terminal device, and a terminal device for presenting the item combination proposal presented by the item combination presenting method to a user are connected to one another through a network, is characterized in that: the item combination presenting device makes a registration application of items the combination of which the item combination presenting device presents, and pays a registration charge to the item combination presenting device through the network when the registration application is made; the item combination presenting device registers the registration-applied items as combination-presented items; the item presenting terminal device transmits item information corresponding to information on the items registration-applied to the item combination device, and item attribute information corresponding to attribute information representing selection standards of the item information; the item combination presenting device receives the item information and the item information attribute information transmitted from the item presenting terminal device, and accumulating plural pieces of item information and item attribute information received, plural pieces of target item information corresponding to information representing target items to be arranged simultaneously with the items, and plural pieces of target item attribute information corresponding to attribute information representing selection standards of the target item information; the terminal device receives a request for specifying the space attribute information; the item combination representing device searches, in response to the request for specifying the target item attribute information input from the terminal device, the target item information having the specified target item attribute information and the item information having the same item attribute information as the target item attribute information from the target item information and the item information accumulated, determining a priority order so that an item for which the highest registration charge is paid by the registration charge payment means of the item presenting device in the items having the searched item information is preferentially adopted for the item combination to be presented, calculating item combination arrangement information representing the simultaneous arrangement of the item information and the target item information according to the determined priority order on the basis of the item information and the target item information searched, and transmits the item combination arrangement information thus calculated to the terminal device; and the terminal device receives the item combination information transmitted from the item combination presenting device and displays the item combination information thus received.

In order to attain the above object, according to the present invention, an item information presenting method for presenting item information to a user is characterized in that prescribed item,, information is searched from plural pieces of item information, priorities are determined to item information to be presented to a user on the basis of predetermined attribute information of items when two or more pieces of item information are searched, and the item information of an item having a higher priority than the item information of an item having a low priority is specified on the basis of the determined priorities and presented to the user.

### BRIEF DESCRIPTION OF THE DRAWINGS

FIG. 1 is a diagram showing the construction of an item combination presenting system according to an embodiment of the present invention;

FIG. 2 is a first flowchart showing the presentation of desired item combination information of a user and the operation of purchasing items in the item combination presenting system shown in FIG. 1;

FIG. 3 is a second flowchart showing the presentation of desired item combination information of a user and the operation of purchasing items in the item combination presenting system shown in FIG. 1;

FIG. 4A is a diagram showing an aspect before a fine adjustment of item combination arrangement information displayed on a display unit of a user terminal device in the item combination presenting system shown in FIG. 1; and

FIG. 4B is a diagram showing an aspect after the fine adjustment of the item combination arrangement information displayed on the display unit of the user terminal device in the item combination presenting system shown in FIG. 1.

### DETAILED DESCRIPTION OF THE PREFERRED EMBODIMENTS

Preferred embodiments of an item combination presenting device, an item combination presenting system and an item combination presenting method according to the present invention will be described hereunder with reference to the accompanying drawings.

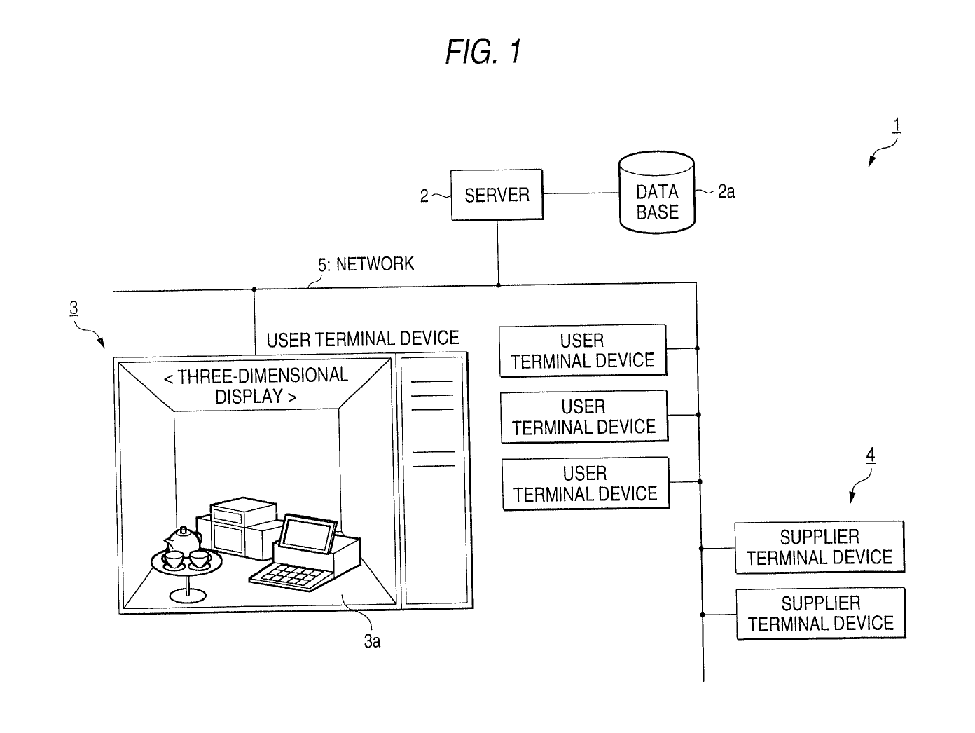

The present invention is applied to an item combination presenting system 1 as shown in FIG. 1.

The item combination presenting system 1 includes a server 2 having a data base 2a, user terminal devices 3 each having a display portion for outputting image information, and supplier terminal devices 4.

Here, items used in the item combination presenting system 1 according to this embodiment will be described.

The items correspond to goods which are presented from the supplier terminal device 4 described below and arranged in a space like furniture, home electronic products, etc. while forming various combinations dependently on the space in which the goods are arranged, the color and shape of the goods, the arrangement way and the correlation with other goods. The items which the supplier terminal devices 4 can present are not limited to ones which should be arranged in the space, but may be ones which can be combined with each other, such as a table and a vase put on it. Further, the items which the supplier terminal devices 4 can present are not limited to actual goods such as furniture, home electronic products, but may contain digital contents such as sounds, pictures, computer software.

The server 2 includes the data base 2a in which item information comprising character information, image information and sound information is accumulated. In response to a request from each user terminal device 3, a controller (not shown) of the server 2 calculates a combination of user's favorable items from the item information accumulated in the data base 2a, transmits the item combination thus calculated as item combination information comprising character information, image information and sound information to the user terminal device 3 and displays the information on the display portion of the user terminal device 3.

When calculating the item combination information to be transmitted to the user terminal device 3, the controller of the server 2 adds the item combination information with item selling information for selling each item on an item basis. The item selling information is information representing the price of each item, the selling address of the item and an item purchasing manner.

According to the item purchasing method, for example, by clicking each item represented by the item combination information displayed on the display portion of the user terminal device 3, an access to each supplier terminal device 4 of an item presenter can be made to enable a user to purchase his/her desired item. The item selling information is added to the item combination information by the controller of the server 2, whereby the user can make a request for requesting his/her desired item to the supplier terminal device 4 through the user terminal device 3.

The data base 2a is equipped to the server 2, and supplies plural pieces of item information comprising image information, character information and sound information accumulated in response to a request from the controller of the server 2. The data base 2a accumulates plural pieces of item information of items which are input from each supplier terminal device 4 and presented to each user terminal device 3, and plural pieces of item attribute information containing item specification information equipped to each item information. The item attribute information contains not only the item specification information, but also standard information which is based when the a user selects an item. This standard information will be described in detail later. The data base 2a accumulates purchase records of items purchased by a user through his/her terminal device 3 together with a profile.

The information on a space in which various items constituting item combination information are arranged is accumulated as item presenting space information in the data base 2a. The item presenting space information is space information representing a three-dimensional or two-dimensional space which enables users to image a room, for example. Plural pieces of item presenting space information as described above are accumulated in the data base 2a so as to support various users' fancy. Further, the item presenting space information is equipped with item presenting space attribute information representing the attribute of an item presenting space or the like such as broadness of the space. The item presenting space attribute information contains standard information representing a standard when a user selects an item presenting space. The standard information will be described in detail later.

Further, in the data base 2a are accumulated plural pieces of image information and plural pieces of arrangement target item information (character information) for an arrangement target in an item arrangement mode described later. The arrangement target item information is the information on an item on/in/at which an item is arranged, in an item arrangement mode in which a combination of items to be arranged is presented. For example, when a user puts a desired vase on a desk, the vase corresponds to an arrangement item, and the desk corresponds to an arrangement target item for the vase. The relationship between the vase and the desk as described above may be satisfied if the arrangement relationship is inverted (that is, the desk is set as an arrangement item and the vase is set as an arrangement target item). Further, the arrangement target item information has arrangement target item attribute information which is specification information such as the specification of an arrangement target item. The arrangement target item attribute information contains standard information representing a standard when a user selects an arrangement target item. The standard information will be described in detail later.

The user terminal device 3 covers an IC card, PDA (Personal Digital Assistants), PC (Personal Computer), a cellular phone, a digital camera, a digital video camera, etc, each of which is equipped with a display unit such as LCD (Liquid Crystal Display) or CRT (Cathode-Ray Tube), for displaying the item combination information comprising character information and image information as transmitted from the server 2. Further, a combination of the above apparatus which is equipped with a display described above may be used as the user terminal device 3. The display mode of the image information of the item combination information to be displayed on the display portion may be a plane-display in a three-dimensional space, a plane-display in a two-dimensional space or the like, and any display mode containing any expression recognizable by users may be used.

The user terminal device 3 is equipped with an input unit (not shown) for inputting various input information described later to the server 2. The input information contains input information when a desired combination is selected from a menu representing item combinations presented from the server 2, and user's profile (user's personal information) such as the age, the distinction of sex, occupation, unmarried or married, hobby.

The user profile may be input from the input unit every time, or it may be written in a storage unit or the like equipped to the user terminal device 3 in advance and then read out every time an access is made to the server 2. Further, information for limiting the space in which the user arranges items may be input from the input unit of the user terminal device 3. For example, in such a case that furniture is arranged in a space, it may be possible to select desired space information from space information accumulated in the database 2a in advance to set default spaces and then arrange a user's desired combination of furniture in the default spaces. However, if furniture is actually arranged in a space where the user wants to arrange the furniture and the arrangement state of the furniture is presented to the user, a combination which is more coincident with the user's fancy can be presented to the user. Accordingly, the limited space as described above is defined as follows. For example when the use wants arrange furniture in his/her room, the user picks up an image of his/her room with a digital camera or the like and inputs the pickup image information from the user terminal device 3. Such a space (regulated by the user) means a limited space, and the information on this space is referred to as “regulated space information”).

The supplier terminal device 4 is a terminal device which a dealer handles to present items, and supplies information of items through the server 2 to users who utilize the item combination presenting system 1. When the dealers carry out services of presenting items through the item combination presenting system 1, the dealers pay registration charges for use of the system through the supplier terminal device 4 to the server 2 serving as a system operator. The registration charge corresponds to an advertisement publishing fee for introducing items to the user terminal device 3 through the server 2.

The supplier terminal device 4 is equipped with an input unit knot shown) for inputting information to alter the information on an item to be registered or cancel the registration. The registration charge as described above is paid from the input unit through the network in the on-line style.

The supplier terminal device 4 may be designed to present various kinds of items from the server 2 to the terminal device 3 by one supplier terminal device 4, or may be designed to present only one kind of items by one supplier terminal device 4.

Priorities (priority order) are imposed on combination information to be presented from the server 2 to the user terminal devices 3 in accordance with the amount of the registration charge to be paid from each supplier terminal device 4 to the server 2. For example, when user s desired desks to be arranged in a room are registered from the supplier terminal devices 4 of plural different dealers, a desk for which a higher registration charge is paid to the server 2 is more preferentially adopted for an item combination and presented from the server 2 to the user terminal device 3. Conversely, a desk for which the lowest registration charge is paid to the server 2 is finally adopted for the item combination and presented from the server 2 to the user terminal device 3.

Further, when items are registered from the supplier terminal device 4, a condition may be input so that the priority order of items to be presented from the server 2 to the user terminal device 3 is varied in accordance with the time band. For example, when an article (item) developed for targeted young people is registered in the supplier terminal device 4, the priority order of presenting the item is set to be highest in the midnight band where the probability that young people access the item combination presenting system 1 is highest.

The item thus registered has a lower priority order in the daytime during which the frequency at which the targeted young people access the item is lower. On the other hand, the item is preferentially presented to the user terminal device 3 for accesses during the midnight.

The network 5 covers telephone lines, exclusive-use lines, CATV lines, optical fibers, wireless local loops, satellite lines and other kinds of wired or wireless lines, and the server 2, the user terminal devices 3 and the supplier terminal devices 4 are connected to one another through the network 5. The network 5 may be open to be accessible to other servers as in the case of the Internet, and it may be closed so that the server 2, the user terminal devices 3 and the supplier terminal devices 4 are connected to one another.

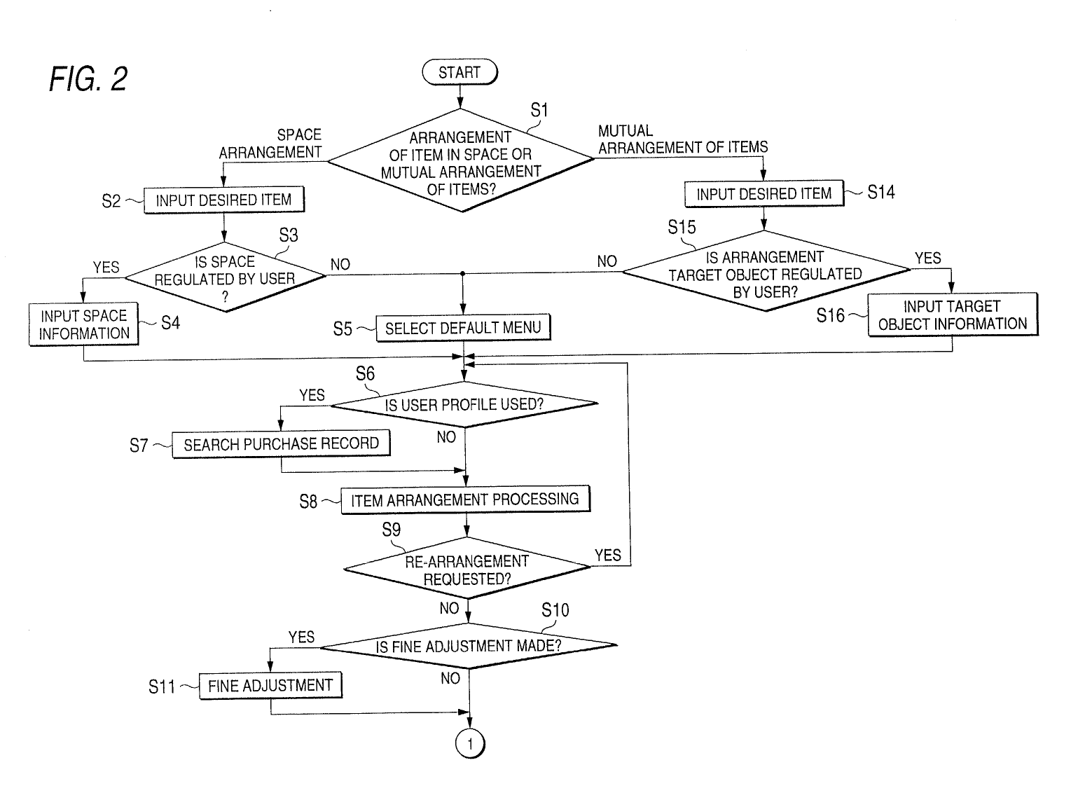

Next, the operation when the server 2 of the item presenting system 1 presents a combination of user's desired items to a user terminal device 3 and the operation when the terminal device 3 purchases items thus presented will be described with reference to the flowchart of FIG. 2.

In step S1, the user selects through the user terminal device 3 a space arrangement mode in which items are arranged in a space, or an item arrangement mode in which items are mutually arranged. In the case of the space arrangement mode, the processing goes to step S2, and in the case of the item arrangement mode, the processing goes to step S14. In this case, it is assumed that in the space arrangement mode, the user requests to combine furniture and home electronic products to be arranged in a user's room with the user's room while in the item arrangement mode, the user requests to combine a vase to be arranged on a table with the table concerned.

The processing going from the step S2 to step S13 corresponds to the space arrangement mode in which the items are arranged in the space.

In step S2, the user selects and inputs one or more desired items through the user terminal device 3. For example, the user selects a table, a tee set, a component stereo apparatus (hereinafter referred to as “stereo”) and PC (Personal Computer).

In step S3, the user judges whether he/she inputs through the user terminal device 3 the regulation space information for regulating the space in which selected items are arranged, or uses the item presenting space information accumulated in the data base 2a in advance.

When the regulated space information is input, the processing goes to step S4, and when the item presenting space information is used, the processing goes to step S5.

In step S4, the user inputs the regulated space information through the user terminal device 3. By using a digital camera or the like, the user picks up an image of the space in which the user wants to arrange the items input in step S2, the user's room (in this case), inputs the digital data from the input unit of the terminal device 3 and transmits them through the network 5 to the server 2. The user's room picked up by the digital camera is spatially regulated because a bed, a TV set, etc. have been already arranged in the room, and thus when the items are arranged in the regulated space, the controller of the server 2 arranges the items in consideration of the arrangeable space.

In step S5, the user selects through the user terminal device 3 the space presented as the default menu (selection of the item and arrangement of the space) by the server 2, also selects desired standard information from the standard information representing standards of the arrangement of the items in the space. The standard information of the item arrangement means information with which an item combination can be presented to the user terminal device 3 with some kind of unification when the user selects various kinds of items registered in the data base 2a. Specifically, when furniture or the like is arranged in a room, a user's desired atmosphere of a room corresponds to the standard information. The item attribute information and the space attribute information which are equipped to the item information and the space information accumulated in the data base 2a respectively contain such standard information.

When registering an item in the data base 2a of the server 2, the supplier terminal device 4 sets as attribute information the standard information of the item. For example, when an item is arranged in a room, the atmosphere of the room that is most suitable to arrange the item therein is set as the standard information. In connection with this operation, the server 2 creates space information having the same standard information as the item registered, and accumulates the space information in the data base 2a. For example, “gorgeous room”, “room in the Japanese style”, “room in the North European style”, “grained room”, etc. may be used as the atmosphere of the room, and the controller of the server 2 creates space information having such standard information, and accumulates it in the data base 2a. Further, the standard information is accumulated as a default menu, for example, when the room is one of the above types, the standard information is accumulated in the data base 2a as user's selectable character information and image information like “gorgeous room”, “room in the Japanese style”, “room in the North European style”, “grained room”. The user selects a menu meeting his/her favorite thing (in the case of the arrangement of furniture or the like, his/her favorite atmosphere) from the default menu serving as a standard for item selection and the arrangement. When the selection of the default menu is finished, the processing goes to step S6.

In step S6, the user judges through the user terminal device 3 whether item combination information using a user profile which is personal information of the user is requested. The server 2 presents combination information of items, and when an item thus presented is purchased, the server 2 accumulates it as a purchase record into the data base 2a together with the user profile corresponding to the personal information of the user who purchases the item. The item combination information using the user profile is combination information of items which have been liked and most frequently purchased by users having the same personal information as the user who wants presentation of items on the basis of the purchase record accumulated in the data base 2a and the user profile input in step S7 described later. If it is judged in step S6 that the item combination information using the user profile is requested, the processing goes to step S7. If no request is made, the processing goes to step S8.

In step S7, on the basis of the user profile and the transmission request of the item combination information using the user profile input through the user terminal device 3 by the user, the server 2 first calculates a user group to which the user concerned belongs The item combination information of items which have been most frequently purchased by users belonging to the user group thus calculated is searched from the purchase record accumulated in the data base 2a. For example, when a user inputs through the user terminal device 3 “twenties as his/her age, “male” as the distinction of sex, “engineer” as the occupation, the controller of the server 2 searches the combination information of most-frequently sold items in accordance with the input user profile from the purchase record of the user concerned which is accumulated in the data base 2a. For example, in the group having the above user profile, when the item combination corresponding to “the room in the North European style” is most frequently sold, out of the item information thereof, the item information of the item selected by the user in step S2 is searched from the data base 2a. When the search of the purchase record using the user profile is finished, the processing goes to step S8.

In accordance with the search result of the data base 2a in step S6 or S7, in step S8 the controller of the server 2 carries out the arrangement processing of arranging the items represented by the item combination information in the space represented by the regulated space information or the item presenting space information. In accordance with the arrangement processing, item combination arrangement information when items are arranged in the respective spaces is calculated from the item combination information representing only the combination of the items by the controller of the server 2.

The controller of the server 2 adds item selling information for selling each item to the item combination arrangement information thus calculated every item. The item selling information contains the price of each item, the selling destination of the item, the purchasing method of the item, for example. The item combination arrangement information added with the item selling information is transmitted from the server 2 through the network 5 to the user terminal device 3.

The controller of the user terminal device 3 outputs image information and character information to the display unit in accordance with the item combination arrangement information thus transmitted. An example of the image information output to the display unit of the user terminal device 3 is shown with reference numeral 3a in FIG. 1.

In this case, a table, a tee set, a stereo and PC which are user's desired items and input through the user terminal device 3 in the step S2 are output and displayed as three-dimensional images. When plural pieces of item combination arrangement information are output and displayed, they are successively displayed on the display unit of the user terminal device 3 in the priority order. When the processing is passed through the step S7 an the user profile information is used, the priority order corresponds to the reducing order of the population of purchasers in the purchase record searched. When the processing is not passed through the step S7, the priority order is set so that the item combination information is output and displayed in the order of reducing the amount of the registration charge registered in the supplier terminal device 4. In the case of items which have been developed for only young people, in place of the order of the amount of the registration charge, the priority order may be set so that the items are preferentially output and displayed in some time band, for example, in a midnight time band in which the young people would most frequently use the item combination presenting system 1. With respect to the items thus contracted, the priority order of presentation is set to be high in the midnight time band, for example.

Even when the processing is passed through the step S7, in accordance with the contract content at the item registration time between the server 2 and the supplier terminal device 4, the priority order may be set in accordance with the registration charge or varied in accordance with the time band, or the above setting manners of the priority order may be combined with each other. When the user checks through the user terminal device 3 all the item combination arrangement information presented from the server 2 in step S8, the processing goes to step S9.

In step S9, the user judges through the user terminal device 3 whether desired item combination arrangement information exists in the item combination arrangement information that are transmitted from the server 2 to be output and displayed on the display portion of the user terminal device 3. If no desired item combination information exists, the user carries out the input operation again and judges whether a re-arrangement request for transmitting another item combination arrangement information is made or not. If no re-rearrangement request is made, it is judged that the user's desired item combination arrangement information exists in the item combination arrangement information transmitted from the server 2 at this time point. If the re-arrangement request is made in step S9, the processing returns to step S6. If no re-arrangement request is made, the processing goes to step S10.

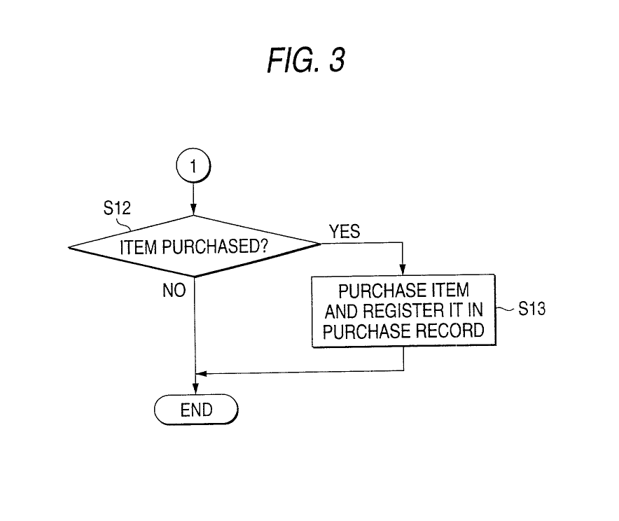

In step S10, the user judges through the user terminal device 3 whether the user is desired item combination arrangement information in the item combination arrangement information presented from the server 2 is subjected to fine adjustment. The fine adjustment of the item combination arrangement information is a work of adjusting the item combination arrangement information so that the item combination arrangement information is more closely approached to the user's fancy when it is unnecessary to change the overall item combination arrangement information, for example, like a case where the user is substantially satisfied with the his/her desired item combination arrangement information transmitted from the server 2, however, the user wants to make a fine (small) change to the item combination arrangement information, for example, he/she wants to displace the position of a desk to the left or change the color of a tee set from red to white. When the fine adjustment is made, the processing goes to step S11. If no fine adjustment is made, the processing goes to step S12 shown in FIG. 3.

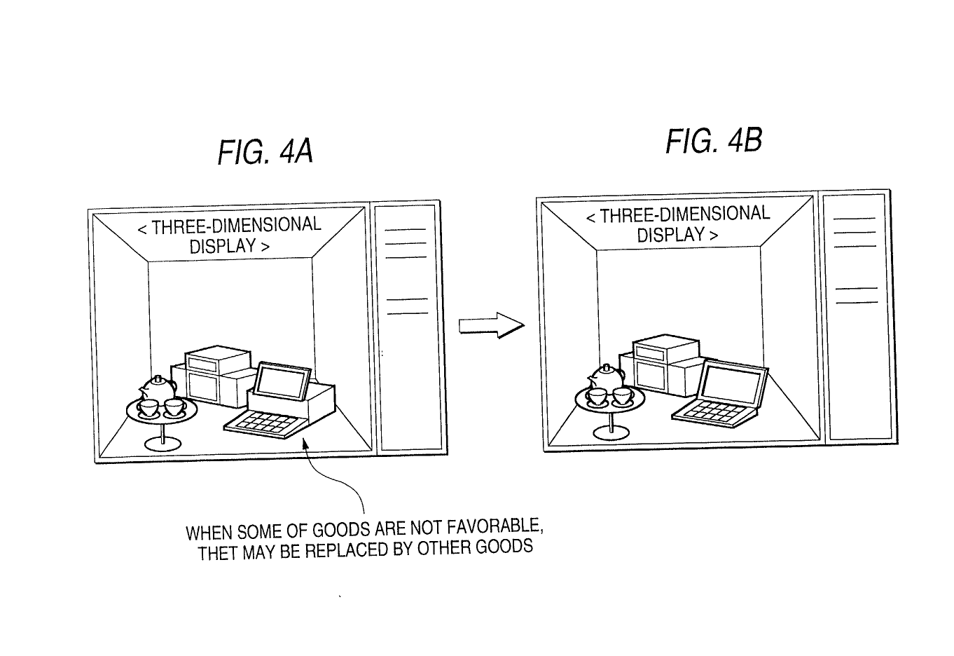

In step S11, the user selects through the user terminal device 3 the desired item combination arrangement information from the item combination arrangement information transmitted from the server 2 and carries out the fine adjustment. The adjusted corrected information is transmitted from the user terminal device 3 through the network 5 to the server 2. For example, it is assumed that the item combination arrangement information is transmitted from the server 2 through the network 5 to the user terminal device 3, and then output and displayed on the display unit of the user terminal device 3 as shown in FIG. 4A. At this time, it is also assumed that the user watches the display screen of the display unit and does not like PC arranged at the right end of the display screen. In this case, the user makes the fine adjustment by continuing to click until desired PC is displayed on the display screen.

FIG. 4B shows an example of item combination arrangement information after the fine adjustment. The manufacturing companies, prices, references, specifications, etc. of the items displayed are displayed as character information at the right end portion of the image information on the screen shown in FIGS. 4A and 4B. When the corrected information is transmitted to the server 2, the processing goes to step S13 shown in FIG. 3. In step S13, the user judges through the user terminal device 3 whether he/she purchases an item represented by the item combination arrangement information transmitted from the server 2. If the user purchases an item, the processing goes to step S13. If the user purchases no item, the processing is finished.

In step S13, through the user terminal device 3, the user makes an input to purchase an item shown in the item combination arrangement information transmitted from the server 2. The user can purchase one or more items in the items shown by the item combination arrangement information. The user can purchase desired items in the on-line style by directly accessing the supplier terminal device 4 through the network 5 and carrying out predetermined processing. For example, the user refers to the item combination information displayed on the user terminal device 3, and clicks a display frame on which a desired item is displayed, whereby the user can access the supplier terminal device 4 which is the selling side of the item. The supplier terminal device 4 carries out various item selling works of collecting payment of the item accessed, deciding a delivery manner of the item with the user terminal device 3 (hereinafter referred to as “item purchasing work”).

When the item purchasing work is finished, item purchase information representing that the item is purchased is transmitted to the server 2 together with the user profile of the user who purchased the item, and accumulated in the purchase record of the data base 2a every user. When the item purchase information is accumulated in the purchase record of the data base 2a, all the processing in the space arrangement mode is completed.

The processing going to the steps S14 to S16 and the steps S6 to S13 corresponds to the item arrangement mode in which arrangement combinations between items are presented.

In step S14, through the user terminal device 3, the user selects and inputs items which the user wants to arrange. For example, it is assumed that the user selects a desk and a vase to be put on the desk. When the item selection is finished, the processing goes to step S15.

In step S15, the user judges through the user terminal device 3 whether an arrangement target object should be regulated or the like. In step S14, the desk and the vase to be arranged on the desk are specified as the arrangement target object. However, for example when a desk owned by the user is set as the desk specified in the step S14, the desk owned by the user is set as an arrangement target object on which the vase is arranged. The relationship between the vase and the desk may be inverse, that is, the vase may be set as an arrangement target object. When an arrangement target object is input, the processing goes to step S16. When no arrangement target object is input, the processing goes to step S5.

In step S16, the user inputs arrangement target information through the user terminal device 3. For example, when the desk is input as an arrangement target object, the user picks up an image of the desk by a digital camera or the like, and inputs the digital information thereof from the input unit of the user terminal device 3 and transmits through the network 5 to the server 2. Data of desks which satisfy the specification of the maker, the manufacturing number, etc. of a desk to be registered as an arrangement target object may be read out from the data base 2a in which the item information is accumulated, or data of a desk to be registered as an arrangement target object are downloaded from a data base accumulated in another server as an Internet resource, thereby inputting the arrangement target object. When the input of the arrangement target object is finished, the processing goes to step S5.

In the item arrangement mode, the space information is not used, but the arrangement target item information is used, and the same processing as the steps S5 to S13 in the space arrangement mode is used except that a default menu obtained from the item attribute information and the standard information of the arrangement target item attribute information is presented to the user in step S5 (default menu selection) and the regulated space information or the item presenting space information used in the space arrangement mode is not used in step S8 (item arrangement processing), and the controller of the server 2 calculates the item combination arrangement information from the item combination information. In the item combination presenting system 1, when the combination of the items registered in the data base 2a of the server 2 is presented to the user through the user terminal device 3, the standard information serving as the standards of the selection of items and spaces is provided to the item attribute information, the space attribute information and the arrangement target item attribute information, the server 2 presents the standard information as the default menu when an item is selected, and the user selects desired standard information from the default menu, whereby the combinations of users' favorite items can be presented to the users by a simple method.

Further, on the basis of the user profile serving as the personal information of the user, the server 2 of the item combination presenting system 1 determines a group that is coincident with the user's fancy, calculates the item combination arrangement information from the item purchase record of the group, and transmits the item combination arrangement information to the user terminal device 3, whereby the combination arrangement information of items coincident with the user's fancy can be presented.

The dealers which present items from the supplier terminal devices 4 of the item combination presenting system 1 through the user terminal devices 3 to users can enhance the advertisement effects of the items by using the item combination presenting system 1 in accordance with the variation of the priority order of the item information transmitted to the user terminal devices 3 with the registration charge paid to the operator operating the item combination presenting system 1 when items are registered.

Next, an item information presenting method according to the present invention will be described in detail.

The item information presenting method of the present invention is not limited to the above-described item combination presenting system 1, and may be broadly used in such a case that item information of image information and/or character information and/or sound information of items is presented to users.

For example, in a case where a user selects two or more desired pieces of item information from the item information accumulated in the data base when the item information is presented to the user, the priority when the item information is presented is determined on the basis of the item attribute information set every item described below.

The item attribute information is mainly classified into registration charge attribute information set on the basis of the registration charge paid by a registrant when the registrant registers an item, and user attribute information set on the basis of a user to which the item information is presented.

The registration charge attribute information is the registration charge to be paid from the registrant to the operator of the system when the registrant registers an item information to be presented to users, or the prescribed value corresponding to the registration charge. If the registration charge attribute information is large, that is, the registration charge to be paid by the registrant or the prescribed value corresponding to the registration charge is larger, the priority when the item information is presented to the users is higher.

The user attribute information is constructed by various items such as the access time band of a user, the age layer of the user, the distinction of sex of the user, hobbies of the users. When a registrant registers item information to be presented to users, the registrant selects zero or one or more items from the items of the user attribute information, and sets parameters for specifying desired target people every selected item. The parameters for specifying the target people are parameters for specifying users to whom the registrant wants to present the registered item most frequently. For example, the parameters are set like “from 23 o'clock to 24 o'clock at night” for the item of the user's access time band, “from 60 years old to 64 years old” for the term of the user's age, “female” for the distinction of sex of user, “potted dwarf tree”, gourmet” for the item of user's hobby, etc.

When the registrant is a florist and he/she plans a new flower pot “yellow and rectangular flower pot” to sell it, the registrant selects the items of the user's access time band, the user's age layer, the user's distinction of sex, the user s hobby, etc. from the items of the user attribute information and sets in the selected items parameters for specifying users who may purchase “the yellow and rectangular flower pot” like “from 23 o'clock to 24 o'clock at night”, “from 60 years old to 64 years old”, “female”, “potted dwarf tree, gourmet”, etc., whereby the intention of the registrant is reflected to the parameters.

Further, the items which are selected from the user attribute information and to which parameters for specifying target users are set are added with a predetermined score (points) by the registrant. This score corresponds to the registration charge when the registrant registers the item. The registrant pays the registration charge corresponding to the total score allocated to the selected item to the operator operating the system for presenting the item information to users. For example, when a registrant A registers the item information of an item “yellow and rectangular flower pot” and the user attribute information is set so that 4 points are allocated to “23 o'clock to 24 o'clock at night” for the user's access time band, 3 points are allocated to “60 years old to 64 years old” for the user's age layer, 1 point is allocated to “female” for the user's distinction of sex, 3 points are allocated to “potted dwarf tree” for the user's hobby and 2 points are allocated to “gourmet” for the user's hobby, the user pays the registration charge corresponding to the total points (13 points). For example, if 1 point is equivalent to 100,000 yen, the registrant pays the registration charge of 1,300,000 yen corresponding to 13 points. The priority of the presentation of item information to users on the basis of the user attribute information is set to be higher for item information having a higher total score allocated to each item of the user attribute information. For example, it is assumed that a user wishes the presentation of the item information of an item “yellow and rectangular flower pot” and an item information presenting device for presenting the item information to users in response to the user's wish shows two pieces of item information (item information a′ of an item a registered by a registrant A and item information b′ of an item b registered by a registrant B). Assuming that the registrant A sets the user attribute information so that the total score allocated to the user attribute information of the item a′ is equal to 13 points while the registrant B sets the user attribute information so that the total score allocated to the user attribute information of the item b′ is equal to 10 points, the item information a′ of the item a registered by the registrant A is more preferentially presented to the users.

On the basis of the priorities determined on the basis of the registration charge attribute information or the user attribute information, item information having a higher priority is specified by the following first to sixth specifying methods while attracting more attention from users than item information having a lower priority, and presented to the users.

A first specifying method for specifying the item information is to display item information having a higher priority in a display area on the display screen to which users first may direct their eyes with high probability, for example, at the upper end portion or left upper end portion on the display screen of a monitor for displaying the item information to be presented to the users.

A second specifying method is to maximize the display area of the item information having high priorities in the item information to be displayed on the screen of the monitor.

A third specifying method is to ornament the display area of the item information having the high priorities to be displayed on the screen of the monitor, for example by framing the display area.

A fourth specifying method is to make the output timing of item information having a higher priority earlier than that of item information having a lower priority in the item information to be output from the monitor device.

A fifth specifying method is to continue to output item information having a higher priority for a longer time than item information having a lower priority in the item information to be output from the monitor device.

A sixth specifying method is to specify item information having high priorities by combining the above first to fifth specifying methods with one another in any way, and presented to the users.

The first to sixth specifying methods may be selected on the basis of a user's instruction.

As described above, the item information having higher priorities is specified with respect to the item information having lower priorities, according to the first to sixth specifying methods, on the basis of the priorities determined from the registration charge attribute information or the user attribute information, whereby a registrant who presents the item information to users can select his/her intended item information from the item information to be presented to the users, and present uses to whom the registrant intends to present the item information.

As apparent from the foregoing description, in accordance with the request for specifying the space attribute information input from the terminal device, the item combination presenting apparatus, the item combination presenting system and the item combination presenting method of the present invention search the space information having the space attribute information specified by the searching means of the item combination presenting apparatus and the item information having the same item attribute information as the space attribute information from the accumulation means, the item combination arrangement information including the image information and the character information when the item information is arranged in the space information is calculated by using the item information and the space information searched by the calculating means, and the item combination arrangement information thus calculated is transmitted to the terminal device to be displayed on the display unit of the terminal device, whereby the item combination meeting the user's fancy can be presented to users by a simple operation. Further, the priority order determining means of the item combination presenting apparatus determines the priority order so that an item combination of items for which high registration charges are paid by the registration charge payment means of the item presenting apparatus is preferentially adopted, and the priority order thus determined is applied when the item combination arrangement information is calculated by the calculating means, thereby performing the item supply meeting the business development of the item presenting terminal device and the increasing business development.

As is apparent from the foregoing description, according to the item combination presenting apparatus, the item combination presenting system and the item combination presenting method of the present invention, in response to the request for specifying the target item attribute information input from the terminal device, the target item information having the target item attribute information specified by the searching means of the item combination presenting apparatus and the item information having the same item attribute information as the target item attribute information are searched from the accumulation means, the item combination arrangement information including the image information and the character information when the item information and the target item information are simultaneously arranged is calculated by using the item information and the target item information searched by the calculation means, and the item combination arrangement information thus calculated is transmitted to the terminal device to be displayed on the display unit of the terminal device, whereby the item combination meeting the user's fancy can be presented with a simple operation. Further, the priority order determining means of the item combination presenting apparatus determines the priority order so that an item combination of items for which high registration charges are paid by the registration charge payment means of the item presenting apparatus is preferentially adopted, and the priority order thus determined is applied when the item combination arrangement information is calculated by the calculating means, whereby the item supply meeting the business development of the item presenting terminal device and the increasing business development can be performed.

As is apparent from the foregoing description, the item information presenting method of the present invention searches desired item information from the plural pieces of item information, determines the priorities of the item information to be presented to users on the basis of the preset item attribute information when two or more pieces of item information are searched, specifies the item information of items higher in priority than the item information of items having low priorities on the basis of the priority order thus determined and then presents the item information thus specified to users, whereby the item supply meeting the business developments of dealers presenting the item information to the users and the increasing business developments can be performed.

What is claimed is:

1. An item combination presenting apparatus for presenting an item combination proposal to a terminal device connected to a network, characterized by comprising:
accumulating means for accumulating plural pieces of item information corresponding to information on items, plural pieces of item attribute information corresponding to attribute information including selection standards of the item information, plural pieces of space information corresponding to information representing a space in which items are arranged, and plural pieces of space attribute information corresponding to attribute information representing selection standards of the space information;
searching means for searching, in response to a request for specifying space attribute information input from a terminal device, space information having space attribute information thus specified and item information having the same item attribute information as the space attribute information from the space information and the item information accumulated in said accumulating means;
calculating means for calculating, on the basis of the item information and the space information searched by said searching means, item combination arrangement information representing the arrangement of the item information in the space information; and
transmitting means for transmitting the item combination arrangement information thus calculated by said calculating means to the terminal device.

2. The item combination presenting apparatus as claimed in claim 1, wherein the item combination arrangement information contains item purchase information with which the item concerned can be purchased from said terminal device via the network, and said accumulating means accumulates as purchase record information an item record representing purchase of an item from said terminal device, and a user attribute representing the attribute of a user who purchases the item concerned.

3. The item combination presenting apparatus as claimed in claim 2, wherein when user attribute information is input from said terminal device, said searching means searches purchase record information having user attribute information meeting input user attribute information from the purchase record information accumulated in said accumulating means to search from the purchase record information item information to which purchase has been frequently recorded.

4. The item combination presenting apparatus as claimed in claim 1, further including receiving means for receiving regulated space information representing a space which is transmitted from said terminal device and regulated by a user, wherein said calculating means adds the regulated space information received by said receiving means to the space information accumulated in said accumulating means to calculate the item combination arrangement information.

5. An item combination presenting method for presenting an item combination proposal to a terminal device connected to a network, characterized in that plural pieces of item information corresponding to information on items, plural pieces of item attribute information corresponding to attribute information representing selection standards of the item information, plural pieces of space information corresponding to information representing a space in which items are arranged, and plural pieces of space attribute information corresponding to attribute information representing selection standards of the space information are accumulated, in response to a request for specifying space attribute information input from a terminal device, space information having space attribute information thus specified and item information having the same item attribute information as the space attribute information are searched from the space information and the item information thus accumulated, on the basis of the item information and the space information thus searched, item combination arrangement information representing the arrangement of the item information in the space information is calculated, and the item combination arrangement information thus calculated is transmitted to the terminal device.

6. The item combination presenting method as claimed in claim 5, wherein the item combination arrangement information transmitted to said terminal device contains item purchase information with which the item concerned can be purchased through said terminal device on the network, and item purchase record representing purchase of an item from said terminal device and user attribute representing the attribute of a user who purchases the item concerned are accumulated as purchase record information.

7. The item combination presenting method as claimed in claim 5, wherein when user attribute information is input by said terminal device, the purchase record information having the user attribute information meeting the user attribute information input is detected from the purchase record information accumulated, and item information having a high purchase record is searched from the purchase record information.

8. The item combination presenting method as claimed in claim 5, wherein regulated space information which is transmitted from said terminal device and represents a space regulated by the user is received and the regulated space information thus received is added to the space information accumulated to calculate the item combination arrangement information.

9. An item combination presenting system in which an item presenting terminal device for presenting items, an item combination presenting device for presenting to a terminal device an item combination proposal of the items presented from the item presenting terminal device, and a terminal device for presenting the item combination proposal presented from the item combination presenting device to a user are connected to one another via a network, characterized in that: said item presenting terminal device includes first transmitting means for transmitting item information corresponding to information on items the combination of which the item combination presenting device presents, and item attribute information corresponding to attribute information representing selection standards of the item information; said item combination presenting device includes first reception means for receiving the item information and the item attribute information transmitted by said first transmitting means of the item presenting terminal device, accumulating means for accumulating plural pieces of item information and item attribute information received by said first reception means, plural pieces of space information corresponding to information representing a space in which items are arranged, and plural pieces of space attribute information corresponding to attribute information representing selection standards of the space information, searching means for searching, in response to a request for specifying space attribute information input from a terminal device, space information having space attribute information thus specified and item information having the same item attribute information as the space attribute information from the space information and the item information accumulated in said accumulating means, calculating means for calculating, on the basis of the item information and the space information searched by said searching means, item combination arrangement information representing the arrangement of the item information in the space information, and second transmitting means for transmitting the item combination arrangement information thus calculated by said calculating means to the terminal device; and said terminal device includes input means for receiving the request for specifying the space attribute information, second reception means for receiving item combination information transmitted from said second transmitting means of said item combination presenting device, and display means for displaying the item combination information received by said second reception means.

10. The item combination presenting system as claimed in claim 9, wherein said calculating means of said item combination presenting apparatus adds the item combination arrangement information thus calculated with item selling information for selling the item concerned on the network, and said terminal device includes item purchasing means for accessing the item selling information added to the item combination arrangement information to purchase the item.

11. The item combination presenting system as claimed in claim 10, wherein said accumulating means of said item combination presenting apparatus accumulates as purchase record information the purchase record of an item purchased by said item purchasing means and transmitted to said item combination presenting apparatus, and user attribute information representing the attribute of a user who purchases the item concerned.

12. The item combination presenting method as claimed in claim 11, wherein said searching means of said item combination presenting apparatus detects the purchase record information having the user attribute information meeting the input user attribute information from said terminal device from the purchase record information accumulated in said accumulating means, and searches item information having a high purchase record from the purchase recording information.

13. The item combination presenting system as claimed in claim 10, wherein said item combination presenting apparatus includes receiving means for receiving regulated space information representing a space regulated by a user, which is input from said terminal device, and said calculating means adds the regulated space information received by said receiving means to the space information accumulated in said accumulating means to calculate the item combination arrangement information.

14. An item combination presenting method in which an item presenting terminal device for presenting items, an item combination presenting device for presenting to a terminal device an item combination proposal of the items presented from the item presenting terminal device, and a terminal device for presenting the item combination proposal presented by the item combination presenting method to a user are connected to one another through a network, characterized in that: said item presenting terminal device transmits item information corresponding to information on items the combination of which said item combination presenting device presents, and item attribute information corresponding to attribute information representing selection standards of the item information; said item combination presenting device receives the item information and the item attribute information transmitted by said item presenting terminal device, and accumulates plural pieces of item information and item attribute information received, plural pieces of space information corresponding to information representing a space in which items are arranged, and plural pieces of space attribute information corresponding to attribute information representing selection standards of the space information; and said terminal device receives a request for specifying the space attribute information, wherein the item combination presenting device searches, in response to a request for specifying the space attribute information input from the terminal device, the space information having the space attribute information specified from the space information and the item information accumulated, and the item information having the same item attribute information as the space attribute information, calculates, on the basis of the item information and the space information searched, item combination arrangement information representing the arrangement of the item information in the space information, and transmits the item combination arrangement information thus calculated to said terminal device, and said terminal device receives the item combination information transmitted from said item combination presenting device and displays the item combination information thus received.

15. The item combination presenting method as claimed in claim 14, wherein said item combination presenting apparatus adds the item combination arrangement information thus calculated with item selling information for selling the item concerned on the network, and said terminal device accesses the item selling information added to the item combination arrangement information to purchase the item.

16. The item combination presenting method as claimed in claim 15, wherein said item combination apparatus accumulates as purchase record information the purchase record of an item purchased by said terminal device which is transmitted to said item combination presenting apparatus, and user attribute information representing the attribute of a user who purchases the item concerned.

17. The item combination presenting method as claimed in claim 15, wherein said item combination presenting apparatus detects, from the accumulated purchase record information, purchase record information having user attribute information meeting user attribute information input from said terminal device, and searches item information having a high purchase record from the purchase record information.

18. The item combination presenting method as claimed in claim 13, wherein said item combination presenting device receives regulated space information representing a space regulated by a user, which is input from said terminal device, and adds the regulated space information thus received to the accumulated space information to thereby calculate the item combination arrangement information.

19. An item combination presenting system in which an item presenting terminal device for presenting items, an item combination presenting device for presenting an item combination proposal of items presented by the item presenting terminal device to a terminal device, and a terminal device for presenting the item combination proposal presented by the item combination presenting device to a user are connected to one another through a network, characterized in that: said item presenting terminal device includes first transmitting means for transmitting information of items for which a combination is presented in the item combination presenting device, and item attribute information corresponding to attribute information containing a selection standard of the item; said item combination presenting device includes registering means for registering as combination-presented items transmitted from said first transmitting means of said item presenting terminal device, first receiving means for receiving the item information and the item attribute information transmitted by the first transmitting means of the item presenting terminal device, accumulating means for accumulating plural pieces of item information and item attribute information received by the first receiving means, plural pieces of space information corresponding to information representing a space in which items are arranged, and plural pieces of space attribute information corresponding to attribute information representing selection standards of the space information, searching means for searching, in response to a request for specifying space attribute information input from the terminal device, the space information having the space attribute information thus specified and the item information having the same item attribute information as the space attribute information from the space information and the item information accumulated in the accumulation means, priority order determining means for determining a priority order so that an item registered by said registering means of said item combination presenting device whose registration charge is high in the items having the item information searched by the searching means is preferentially selected for an item combination to be presented to said terminal device, calculation means for calculating item combination arrangement information when the item represented by the item information is arranged in the space represented by the space information, on the basis of the item information and the space information searched by the searching means according to the priority order determined by said priority order determining means, and second transmitting means for transmitting the item combination arrangement information calculated by the calculating means to said terminal device; and said terminal device includes input means for receiving a request for specifying space attribute information, second receiving means for receiving the item combination information transmitted from said second transmitting means of said item combination presenting device, and display means for displaying the item combination information received by said second receiving means.

20. The item combination presenting system as claimed in claim 18, wherein said calculating means of said item combination presenting device adds the item combination arrangement information calculated with item selling information for selling the item concerned on the network, and said terminal device includes item purchasing means for accessing the item selling information added to the item combination arrangement information to purchase the item.

21. The item combination presenting system as claimed in claim 20, wherein said accumulating means of said item combination presenting device accumulates as purchase record information the purchase record of an item purchased by said terminal device and the user attribute information representing the attribute of a user who purchases the item concerned, detects, from the purchase record information accumulated in said accumulation means, the purchase record information having the user attribute information meeting the user attribute information input from said terminal device, and searches from the purchase record information an item having high purchase record information.

22. The item combination presenting system as claimed in claim 21, wherein said item combination presenting device includes third receiving means for receiving regulated space information representing a space regulated by a user, which is transmitted from said terminal device, and said calculating means adds the regulated space information received by said third receiving means to the space information accumulated in said accumulating means to thereby calculate the item combination arrangement information.

23. The item combination presenting system as claimed in claim 19, wherein said priority order determining means of said item combination presenting device determines the priority order of items registered by said registering means so that the items are preferentially adopted for an item combination to be presented to said terminal device in response to an access from a terminal device in a prescribed time band, and said calculating means calculates the item combination in accordance with the priority order determined by said priority order determining means when an access is made in the prescribed time band from said terminal device.

24. An item combination presenting method in which an item presenting terminal device for presenting items, an item combination presenting device for presenting an item combination proposal of items presented by the item presenting terminal device to a terminal device, a terminal device for presenting the item combination proposal presented by the item combination device to a user are connected to one another through a network, characterized in that: the item presenting terminal device transmits the item information of the item concerned and the item attribute information representing the selection standard of the item as the item for which the combination is presented in said item combination presenting device; the item combination presenting device receives the item information and the item attribute information transmitted from the item presenting terminal device, accumulates plural pieces of item information and plural pieces of item attribute information thus received, and plural pieces of space information corresponding to the information representing a space in which the items are arranged, and plural pieces of space attribute information representing the selection standards of the space information, searches the space information having the space attribute information and the item information having the same item attribute information as the space attribute information from the space information and the item information accumulated in response to a request for specifying the space attribute information input from said terminal device, determines a priority order so that an item in the items having the searched item information for which the item registration charge registered by said item combination presenting device is high is preferentially adopted for an item combination to be presented to said terminal device, calculates item combination arrangement information when the item represented by the item information is arranged in the space represented by the space information, according to the determined priority order on the basis of the item information and the space information thus searched, and transmits the item combination arrangement information thus calculated to the terminal device; and the terminal device receives the item combination information transmitted from the item combination presenting device, and displays the item combination information thus received.

25. The item combination presenting method as claimed in claim 24, wherein said item combination presenting device adds the calculated item combination arrangement information with item selling information for selling the item concerned on the network, and said terminal device accesses the item selling information added to the item combination arrangement information to purchase the item.

26. The item combination presenting method as claimed in claim 25, wherein said item combination presenting device accumulates as purchase record information the purchase record of an item purchased by said terminal device, and user attribute information representing the attribute information of a user who purchases the item concerned, detects from the accumulated purchase record information the purchase record information having the user attribute information meeting the user attribute information representing the attribute of the user which is input from said terminal device, and searches from the purchase record information an item having highly-frequent purchase record information.

27. The item combination presenting method as claimed in claim 24, wherein said item combination presenting device receives regulated space information representing a space regulated by a user from said terminal device, and adds the received regulated space information to the accumulated space information to calculate the item combination arrangement information.

28. The item combination presenting system as claimed in claim 24, wherein said item combination presenting device determines the priority order of registered items so that the items are preferentially adopted for an item combination to be presented to said terminal device in response to an access from said terminal device in a prescribed time bands and said terminal device calculates the item combination in accordance with the priority order thus determined when an access is made from said terminal device in the prescribed time band.

29. An item combination presenting apparatus for presenting an item combination proposal to a terminal device connected thereto through a network, characterized by including:
accumulating means for accumulating plural pieces of item information corresponding to information on items, plural pieces of item attribute information corresponding to attribute information representing the selection standards of the item information, plural pieces of target item information corresponding to information representing target items arranged simultaneously with the items, and plural pieces of target item attribute information corresponding to attribute information representing the selection standards of the target items;
searching means for searching, in response to a request for specifying target item attribute information input from said terminal device, the target item information having the specified target item attribute information and the item attribute information containing the target item attribute information from the target item information and the item information accumulated in said accumulating means;
calculating means for calculating item combination arrangement information when the item having the item information and the target item having the target item information are simultaneously arranged, on the basis of the item information searched by said searching means and the target item information searched by said searching means; and
transmitting means for transmitting the item combination arrangement information calculated by the calculating means to the terminal device.

30. The item combination presenting apparatus as claimed in claim 29, wherein the item combination arrangement information contains item purchase information with which the item concerned can be purchased through said terminal device on the network, and said accumulating means accumulates, as purchase record information, item purchase record indicating purchase of an item from said terminal device and user attribute information representing the attribute of a user purchasing the item.

31. The item combination presenting apparatus as claimed in claim 30, wherein when user attribute information is input purchase record information having user attribute information meeting input user attribute information from the purchase record information accumulated in said accumulating means to search item information having a highly-frequent purchase record from said purchase record information.

32. The item combination presenting apparatus as claimed in claim 29, wherein said item combination presenting apparatus includes receiving means for receiving regulated target item information representing a target item regulated by a user, which is transmitted from said terminal device, and said calculating means adds the target item information accumulated in the accumulating means with the regulated target item information received by said receiving means to calculate the item combination arrangement information.

33. An item combination presenting method for presenting an item combination proposal to a terminal device connected through a network, characterized in that plural pieces of item information corresponding to information on items, plural pieces of item attribute information corresponding to attribute information representing the selection standards of the item information, plural pieces of target item information corresponding to information representing target items arranged simultaneously with the items, and plural pieces of target item attribute information corresponding to attribute information representing the selection standards of the target items are accumulated; in response to a request for specifying target item attribute information input from the terminal device, the target item information having the specified target item attribute information and the item information having item attribute information contained in the target item attribute information are searched from the target item information and the item information accumulated; item combination arrangement information when the item having the item information and the target item having the target item information are simultaneously arranged is calculated on the basis of the item information and the target item information thus searched; and the item combination arrangement information thus calculated is transmitted to the terminal device.

34. The item combination presenting method as claimed in claim 33, wherein the calculated item combination arrangement information contains item selling information for selling the item concerned through said terminal device on the network, and accumulates as purchase record information an item purchase record indicating purchase of an item from said terminal device, and user attribute information representing the attribute of a user purchasing the item concerned.

35. The item combination presenting method as claimed in claim 34, wherein when user attribute information is input by said terminal device, said item combination presenting device detects the purchase record information having the user attribute information meeting the input user attribute information from the purchase recording information accumulated and searches an item having highly-frequent purchase record information from the purchase record information concerned.

36. The item combination presenting method as claimed in claim 33, wherein said item combination presenting device receives regulated target item information representing a target item regulated by a user, which is transmitted from said terminal device, and adds the received regulated target item information to the space information accumulated to calculate the item combination arrangement information.

37. An item combination presenting system in which an item presenting terminal device for presenting items, an item combination presenting device for presenting an item combination proposal of items presented by the item presenting terminal device to a terminal device, and a terminal device for presenting the item combination proposal presented by the item combination presenting device to a user are connected to one another through a network, characterized in that: said item presenting terminal device includes first transmitting means for transmitting item information corresponding to information on items for which a combination is presented by said item combination presenting device, and item attribute information corresponding to attribute information representing selection standards of the item information; said item combination presenting device includes first receiving means for receiving the item information and the item attribute information transmitted by first transmitting means of said item presenting terminal device, accumulating means for accumulating plural pieces of item information and plural pieces of item attribute information received by said first receiving means, plural pieces of target item information corresponding to information representing target items arranged simultaneously with the items, and plural pieces of target item attribute information corresponding to attribute information representing selection standards of the target item information, searching means for searching, in response to a request for specifying target item attribute information input said the terminal device, the target item information having the specified target item attribute information and the item information having the item attribute information contained in the target item attribute information from the target item information and the item information accumulated in said accumulating means, calculating means for calculating item combination arrangement information when the item having the item information and the target item having the target item information are simultaneously arranged, on the basis of the item information searched by the searching means and the target item information searched by the searching means, and second transmitting means for transmitting the item combination arrangement information calculated by said calculating means to said terminal device; and said terminal device includes input means for receiving the request for specifying the target item attribute information, second receiving means for receiving the item combination information transmitted from said second transmitting means of said item combination presenting device, and display means for displaying the item combination information received by said second receiving means.

38. The item combination presenting system as claimed in claim 37, wherein said calculating means of said item combination presenting device adds the item combination arrangement information calculated with item selling information for selling the item concerned on the network, and said terminal device includes item purchasing means for accessing the item selling information added to the item combination arrangement information to purchase the item.

39. The item combination presenting system as claimed in claim 38, wherein said accumulating means of said item combination presenting device accumulates as purchase record information the purchase record of an item purchased by said item purchasing means which is transmitted to said item combination presenting device, and attribute information representing the attribute of a user who purchases the item concerned.

40. The item combination presenting system as claimed in claim 39, wherein when user attribute information is input from said terminal device, said searching means detects the purchase record information having the user attribute information meeting input user attribute information from the purchase record information accumulated by said accumulating means, and searches item information having a highly frequent purchase record from the purchase record information concerned.

41. The item combination presenting system as claimed in claim 37, wherein said item combination presenting device includes receiving means for receiving regulated target item information representing a target item regulated by a user which is input from said terminal device, and said calculating means adds the regulated target item information received by said receiving means to the target item information accumulated in said accumulating means to calculate the item combination arrangement information.

42. An item combination presenting method in which an item presenting terminal device for presenting items, an item combination presenting device for presenting an item combination proposal of items presented by the item presenting terminal device to a terminal device, and a terminal device for presenting the item combination proposal presented by the item combination presenting method to a user are connected to one another through a network, characterized in that the item presenting terminal device transmits item information corresponding to information on items for which a combination is presented by the item combination presenting device, and item attribute information corresponding to attribute information representing selection standards of the item information; the item combination presenting device receives the item information and the item attribute information transmitted from the item presenting terminal device, accumulates plural pieces of item information and plural pieces of item attribute information thus received, plural pieces of target item information corresponding to information representing target items arranged simultaneously with the items, and plural pieces of target item attribute information corresponding to attribute information representing selection standards of the target item information, searches, in response to a request for specifying target item attribute information input from the terminal device, the target item information having the specified target item attribute information and the item information having the same item attribute information as the target item attribute information from the target item information and the item information accumulated, calculates item combination arrangement information representing the simultaneous arrangement of the item information and the target item information on the basis of the item information and the target item information searched, and transmits the item combination arrangement information thus calculated to the terminal device; and the terminal device receives the item combination information transmitted from the item combination presenting device, and displays the item combination information received.

43. The item combination presenting method as claimed in claim 42, wherein said item combination presenting device adds the item combination arrangement information calculated with item selling information for selling the item concerned on the network, and said terminal device accesses the item selling information added to the item combination arrangement information to purchase the item.

44. The item combination presenting method as claimed in claim 43, wherein said item combination presenting device accumulates as purchase recording information the purchase record of the item purchased by said terminal device, and the user attribute information representing the attribute of a user who purchases the item concerned.

45. The item combination presenting method as claimed in claim 42, wherein when user attribute information is input from said terminal device, said item combination presenting device detects purchase record information having the user attribute information meeting input user attribute information from the purchase record information accumulated, and searches item information having a highly-frequent purchase record from the purchase record concerned.

46. The item combination presenting method as claimed in claim 42, wherein said item combination presenting device receives regulated target item information representing a target item regulated by a user which is input from said terminal device, and adds the regulated target item information received to the target item information accumulated to calculate the item combination arrangement information.

47. An item combination presenting system in which an item presenting terminal device for presenting items, an item combination presenting device for presenting an item combination proposal of items presented by said item presenting terminal device to a terminal device, and a terminal device for presenting the item combination proposal presented by said item combination presenting device to a user are connected to one another through a network, characterized in that: said item presenting terminal device includes first transmitting means for transmitting item information corresponding to information of items for which a combination is presented by said item combination presenting device, and item attribute information corresponding to attribute information containing a selection standard of the item; said item combination presenting device includes registering means for registering as combination-presented items items transmitted from said first transmitting means of said item presenting terminal device, first receiving means for receiving the item information and the item attribute information transmitted by said first transmitting means of said item presenting terminal device, accumulating means for accumulating plural pieces of item information and item attribute information received by said first receiving means, plural pieces of target item information representing a target item to be arranged simultaneously with the items, and plural pieces of target item attribute information which are attribute information containing selection standards of the target item information, searching means for searching, in response to a request for specifying target item attribute information input from said terminal device, the target item information having the target item attribute information thus specified and the item information having the item attribute information contained in the target item attribute information from the target item information and the item information accumulated in said accumulation means, priority order determining means for determining a priority order so that an item registered by said registering means of said item combination presenting device whose registration charge is high in the items having the item information searched by the searching means is preferentially selected for an item combination to be presented, calculation means for calculating item combination arrangement information when the item represented by the item information and the target item represented by the target item information are simultaneously arranged, on the basis of the item information and the space information searched by said searching means according to the priority order determined by said priority order determining means, and second transmitting means for transmitting the item combination arrangement information calculated by said calculating means to a terminal device; and said terminal device includes input means for receiving a request for specifying target item attribute information, second receiving means for receiving the item combination information transmitted from said second transmitting means of said item combination presenting device, and display means for displaying the item combination information received by said second receiving means.

48. The item combination presenting system as claimed in claim 47, wherein said calculating means of said item combination presenting device adds the item combination arrangement information calculated with item selling information for selling the item concerned on the network, and said terminal device includes item purchasing means for accessing the item selling information added to the item combination arrangement information to purchase the item.

49. The item combination presenting system as claimed in claim 48, wherein said accumulating means of said item combination presenting device accumulates as purchase record information the purchase record information of an item purchased by said item purchasing means of said terminal device which is transmitted to said item combination presenting device, and the user attribute information representing the attribute of a user who purchases the item concerned.

50. The item combination presenting system as claimed in claim 49, wherein when user attribute information is input from said terminal device, said searching means detects the purchase record information having the user attribute information meeting input user attribute information from the purchase recording information accumulated in said accumulating means, and searches item information having a highly-frequent purchase record from the purchase record information.

51. The item combination presenting system as claimed in claim 47, wherein said item combination presenting device includes third receiving means for receiving regulated target item information representing a target item regulated by a user, which is transmitted from said terminal device, and said calculating means adds the regulated target item information received by said third receiving means to the space information accumulated in said accumulating means to calculate the item combination arrangement information.

52. The item combination presenting system as claimed in claim 47, wherein said priority order determining means of said item combination presenting device determines the priority order of the items registered in said registering means so that the items are preferentially adopted for the item combination to be presented to said terminal device in response to an access from said terminal device in a prescribed time band, and when an access is made from said terminal device in the prescribed time band, said calculating means calculates the item combination according to the priority order determined by said priority order determining means.

53. An item combination presenting method in which an item presenting terminal device for presenting items, an item combination presenting device for presenting an item combination proposal of items presented by the item presenting terminal device to a terminal device, and a terminal device for presenting the item combination proposal presented by the item combination presenting device to a user are connected to one another through a network, characterized in that: the item combination presenting device transmits item information corresponding to information on the items for which a combination is presented in the item combination presenting device, and item attribute information corresponding to attribute information representing selection standards of the item information; the item combination presenting device receives the item information and the item information attribute information transmitted from the item presenting terminal device, registering as combination-presented item an item having the item information and the item attribute information received, accumulating plural pieces of item information and item attribute information received, plural pieces of target item information corresponding to information representing target items to be arranged simultaneously with the items, and plural pieces of target item attribute information corresponding to attribute information representing selection standards of the target item information, searches, in response to a request for specifying the target item attribute information input from the terminal device, the target item information having the specified target item attribute information and the item information having the item attribute information contained in the target item attribute information from the target item information and the item information accumulated, determining a priority order so that an item for which the highest registration charge is paid by the registering means of the item presenting device in the items having the searched item information is preferentially adopted for the item combination to be presented, calculating item combination arrangement information representing the simultaneous arrangement of the item information and the target item information according to the determined priority order on the basis of the item information and the target item information searched, and transmits the item combination arrangement information thus calculated to the terminal device; and the terminal device receives the item combination information transmitted from the item combination presenting device and displays the item combination information thus received.

54. The item combination presenting method as claimed in claim 53, wherein said item combination presenting device adds the item combination arrangement information calculated with item selling information for selling the item concerned on the network, and said terminal device accesses the item selling information added to the item combination arrangement information to purchase the item.

55. The item combination presenting method as claimed in claim 54, wherein said item combination presenting device accumulates as purchase record information the purchase record of an item purchased by said terminal device and the user attribute information presenting the attribute of a user who purchases the item concerned.

56. The item combination presenting method as claimed in claim 53, wherein when user attribute information is input from said terminal device, purchase recording information having the user attribute information meeting the user attribute information input is detected from the purchase record information accumulated, and item information having a highly-frequent purchase record is searched from the purchase record information.

57. The item combination presenting method as claimed in claim 53, wherein said item combination presenting device receives regulated target item information representing a target item regulated by a user, which is transmitted from said terminal device, and calculates the regulated target item information thus received.

58. The item combination presenting method as claimed in claim 53, wherein the item combination presenting method as claimed in claim 53, wherein said item presenting terminal device determines the priority order of the items registered so that the items are preferentially adopted for the item combination to be presented to said terminal device in response to an access from said terminal device in a prescribed time band, and calculates the item combination according to the determined priority order when an access is made from said terminal device in the prescribed time band.

59. An item information presenting method for presenting item information to a user, characterized in that prescribed item information is searched from plural pieces of item information, priorities are determined to item information to be presented to a user on the basis of predetermined attribute information of items when two or more pieces of item information are searched, and the item information of an item having a higher priority than the item information an item having a low priority is specified on the basis of the priority order thus determined and presented to the user.
